(19) United States
(12) Patent Application Publication
(10) Pub. No.: US 2012/0080825 A1
(43) Pub. Date: Apr. 5, 2012

(54) IMPRINTING LITHOGRAPHY APPARATUS AND IMPRINTING LITHOGRAPHY METHOD

(76) Inventor: Soichiro MITSUI, Kanagawa-ken (JP)

(21) Appl. No.: 13/050,815

(22) Filed: Mar. 17, 2011

(30) Foreign Application Priority Data
Sep. 30, 2010 (JP) P2010-223172

(51) Int. Cl. B29C 59/16; B29C 63/48

(52) U.S. Cl. 264/447; 425/102

(57) ABSTRACT

According to one embodiment, an imprint lithography apparatus includes an arithmetic unit calculating a mixing ratio of a demolding agent and a resist to be contained in a pattern forming agent on a basis of a pattern size formed on a template, a mixer mixing the resist and the demolding agent, a nozzle dropping the pattern forming agent on a substrate from the mixer, and an irradiation apparatus irradiating the pattern forming agent dropped on the substrate with light after pressing the template onto the pattern forming agent.

### CROSS REFERENCE TO RELATED APPLICATION

This application is based upon and claims the benefit of priority from prior Japanese Patent Application No. 2010-223172, filed on Sep. 30, 2010, the entire contents of which are incorporated herein by reference.

### FIELD

Exemplary embodiments described herein generally relate to an imprinting lithography apparatus and an imprinting lithography method.

### BACKGROUND

Realization of microscopic processing has been demanded with miniaturization and higher integration of a semiconductor integrated circuit pattern.

An optical nano-imprint lithography has been developed as one of technologies towards high performance mentioned above.

In this technology a quartz glass, on which a concavo-convex pattern is formed, is pressed onto a substrate, such as a silicon substrate, on which a photo-curable resist is applied. In this state, the photo-curable resist is irradiated with light to be cured. Then, the concavo-convex pattern on the quartz glass is formed on a surface of the substrate by peeling the quartz glass from the substrate.

In other words, the quart glass serves as a template to form a pattern.

A process in the mentioned below has a problem, however. The photo-curable resist adheres to a concavo-convex portion of the template when the template is peeled from the substrate.

The photo-curable resist adhered to the template makes it difficult to form the concavo-convex pattern on the substrate with good accuracy.

### BRIEF DESCRIPTION OF THE DRAWINGS

FIG. 1 is a schematic view showing an imprint lithography apparatus described in a first embodiment;

FIG. 2 is a diagram showing an imprint lithography data described in the first embodiment;

FIG. 3 is a diagram showing the imprint lithography data described in the first embodiment;

FIG. 4 is a flowchart showing an imprint lithography method described in the first embodiment;

FIG. 5 is a schematic view showing an imprint lithography apparatus described in a modification of the first embodiment.

FIG. 6 is a flowchart showing the imprint lithography method described in the modification of the first embodiment.

### DETAILED DESCRIPTION

According to one embodiment, an imprint lithography apparatus includes an arithmetic unit calculating a mixing ratio of a demolding agent and a resist to be contained in a pattern forming agent, wherein the mixing ratio being adjusted on a basis of a pattern size formed on a template, a mixer mixing the resist and the demolding agent on the basis of a calculation result by the arithmetic unit, a nozzle dropping the pattern forming agent on a substrate from the mixer, and an irradiating apparatus irradiating the pattern forming agent dropped on the substrate with light after pressing the template onto the pattern forming agent.

Each embodiment of the invention will be described hereinafter with reference to the drawings. A portion, to which the same reference numeral is given, indicates a similar portion. Note that the drawings are schematic or conceptual, and not always identical to actual ones, in terms of a relation between thickness and width of each portion, a coefficient of size ratio between portions, or the like. In addition, even when the same portion is represented, mutual dimensions or coefficients of ratio may be represented differently, depending on the drawings.

### First Embodiment

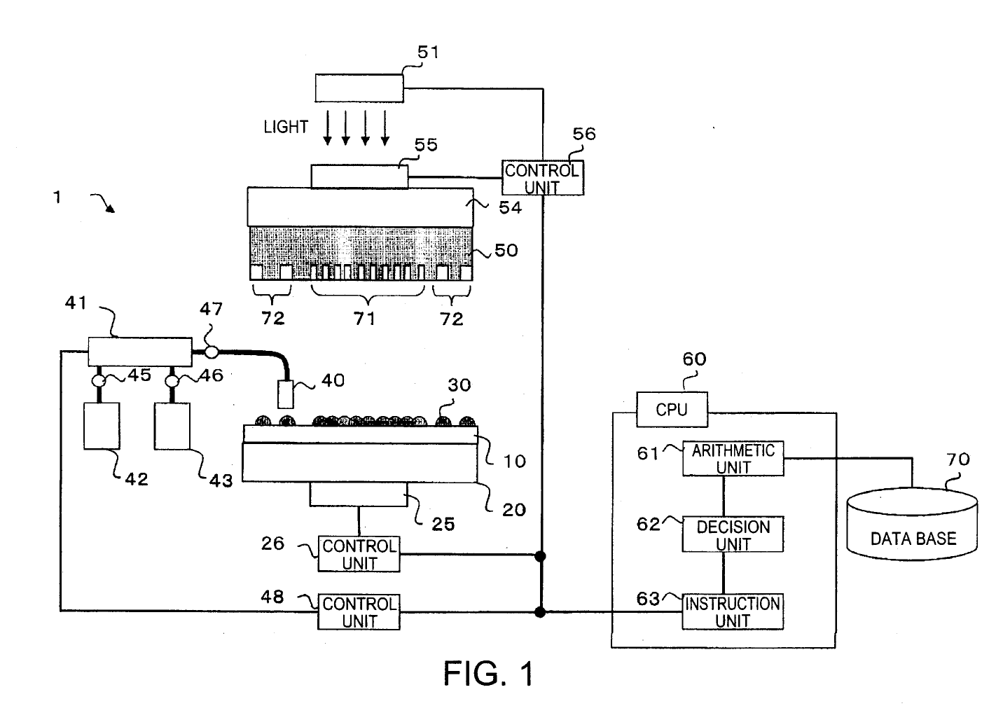

FIG. 1 is a schematic view showing an imprint lithography apparatus 1. The imprint lithography apparatus 1 includes a stage 20 to fix a substrate 10, a nozzle 40 to apply a pattern forming agent 30 onto the substrate 10, a template 50 to be pressed against the pattern forming agent 30 applied onto the substrate 10, a stage 54 to fix the template 50, and an irradiation apparatus 51 to emit light to cure the pattern forming agent 30. A pattern is formed on the substrate 10 by pressing the pattern forming agent 30 with the template 50.

The pattern forming agent 30 is a mixture of a demolding agent 31 and a resist 32.

The resist 32 contains a photopolymerization initiator. The photopolymerization initiator causes a photopolymerization reaction by exposed to irradiation of ultraviolet light, so that the resist 32 involves phase-change and result in a cured polymer. One of acrylic-based, epoxy-based, and vinyl ether-based ultraviolet curable resins or the like, for example, can be used as the resist 32.

The resist 32 can be easily peeled from the template by using the demolding agent 31. A fluorine-based compound, a silicone-based compound, or a silicone acrylic-based resin, for example, can be used as the demolding agent 31. A fluorocarbon-series or perfluoropolyether-series monomer or polymer, for example, can be used as the fluorine-based compound. Polysiloxane, for example, can be used as the silicone-based compound.

The fluorine-based compound or silicone-based compound used as the demolding agent 31 has low surface energy and small attracting forces between molecules due to a resin structure or functional group characteristics, thus resulting in small friction and good demolding performance as features. In addition, a molecular structure of the fluorine-based compound in which an end of the compound is replaced by fluorine, or an almost linear molecular structure of the silicone-based compound, in which a siloxane bond is a host framework, can easily obtain a surface with dense and smooth, so that the demolding agent 31 has a small friction surface.

In an ultraviolet curable resin used as the resist 32, a monomer in liquid state is cured to a solid polymer by a photo-polymerization reaction. Thus, the resist 32 adheres to the template 50 well. This makes it hard to detach the resist 32 from the template 50. In addition, an adherence promoter is added to the resist 32 to improve adhesion to the substrate 10. the adherence promoter inhibits demolding.

A silicon substrate or the like can be used as the substrate 10, for example.

The stage 20 is controlled by a drive unit 25. The drive unit 25 can translate the stage 20 in an xyz direction and rotate the stage 20 in θ-rotation, α-rotation, and β-rotation. θ is a rotation angle of an xy plane around a z axis, while α and β are elevation angles. α is a rotation angle of the xy plane around an x axis, and β is a rotation angle of the xy plane around a y axis.

The nozzle 40 is connected to a mixer 41. The mixer 41 adjusts a mixing ratio of the demolding agent 31 and the resist 32 to create the pattern forming agent 30. The mixer 41 is connected to tanks 42, 43. In addition, mass flow controllers 45, 46, 47 are respectively provided through each piping between the tank 42 and the mixer 41, between the tank 43 and the mixer 41, and between the mixer 41 and the nozzle 40 respectively. The imprint lithography apparatus 1 can also have plural set of nozzles 40.

The demolding agent 31 is provided in the tank 42. The resist 32 is provided in the tank 43.

The template 50 is fixed to the stage 54, and a position of the template 50 is controlled by a drive unit 55. The drive unit 55 moves the template 50 in the x, y, and z directions, and rotates the template 50 in θ-rotation, α-rotation, and β-rotation. In an imprint operation to push the template 50 into the pattern forming agent 30 to bring the template 50 into contact with the pattern forming agent 30, in particular, drive control in the z direction is performed. A positional relation between the template 50 and the substrate 10 is controlled by controlling positions of the stage 20 and the stage 54 in the x, y, or z direction. Quartz glass or the like can be used as the template 50.

The irradiation apparatus 51 is controlled by a control unit 56. The irradiation apparatus 51 is used to irradiate the pattern forming agent 30 with light when the template 50 is pushed into the pattern forming agent 30 The amount of light to be irradiated is set on exposure characteristics of the resist 32, and irradiation time is controlled by the control unit 56.

The drive units 25, 55, and the mixer 41 are respectively controlled by a CPU (Central Processing Unit) 60 through the control units 26, 56, 48 respectively. The CPU 60 includes an arithmetic unit 61, a determine unit 62, and an instruction unit 63. In addition, the CPU 60 is connected to a database 70 through the arithmetic unit 61. The database 70 can be provided either inside or outside of the imprint lithography apparatus 1.

The database 70 stores a data which relates a concavo-convex pattern of the template 50 to the demolding agent 31, and the resist 32, and the database 70 stores a concavo-convex pattern data of the template 50. The concavo-convex pattern data of the template 50 is designed on the basis of device design data. Also, when a circuit of a device such as a DRAM (Dynamic Random Access Memory) is designed, for example, a memory cell is often arranged in a central portion of a chip region. Then, a peripheral circuit around the memory cell is designed in a larger dimension than the memory cell. Thus, in many cases a pattern of the central portion is smaller size than that of a peripheral portion.

The arithmetic unit 61 is connected to the database 70. The arithmetic unit 61 calculates a mixing ratio of the demolding agent 31 with the resist 32 on the basis of the concavo-convex pattern data of the template 50. In this event, the arithmetic unit 61 retrieves the data which relates the concavo-convex pattern of the template 50 to the demolding agent 31 and the resist 32.

The determine unit 62 determines a position to which the pattern forming agent 30 is to be applied and sends a result to the instruction unit 63.

The instruction unit 63 instructs the control portions 26, 56, 48 to operate the drive units 25, 55 and the mixer 41, on the basis of the result sent from the determine unit 62.

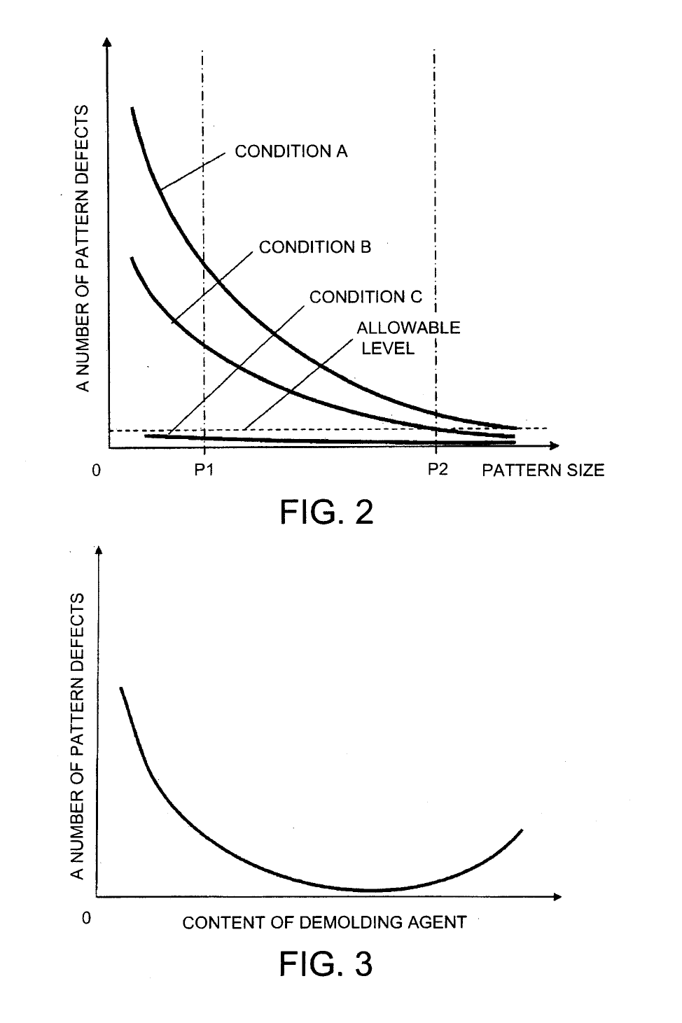

FIG. 2 is a diagram illustrating the data which relates the concavo-convex pattern of the template 50 to the demolding agent 31 and the resist 32. The database 70 stores data on correlation as shown in FIG. 2.

FIG. 2 is a diagram showing a relation between a pattern size of a concavo-convex pattern formed on the template 50 and the number of pattern defects observed when the template 50 is demolded from the substrate 10. The vertical axis indicates the number of defects of the concavo-convex pattern in the pattern forming agent 30 applied on the substrate 10. The horizontal axis indicates the pattern size of the concavo-convex pattern formed on the template 50. The number of pattern defects represents the number of defects observed in a case where a desired pattern does not fit to a pattern which is formed by peeling the template 50 from the pattern forming agent 30. Tearing in a convex portion of the pattern or roughness of the pattern causes the misfit. Deterioration of line edge roughness causes the roughness of the patterns. A detailed description of the number of pattern defects will be described later.

In general, the number of pattern defects depends on which template is used. In other words, the number of pattern defects varies depending on which template is used. Here, the number of pattern defects is defined as the number of defects to be caused by destruction of a resist pattern during a template demolding operation in transfer defect specifications.

Conditions A, B, C indicate the content of the demolding agent 31 contained in the pattern forming agent 30. The condition A has the highest content of the demolding agent 31. The condition B has the second highest content of the demolding agent, following the condition A. The condition C has the lowest content of the demolding agent. The vertical axis and the horizontal axis represent a relation of like an inverse proportion. This is because a surface area of a concavo-convex pattern formed on the template 50 relatively increases when a pattern size becomes smaller, and thus adhesion of the pattern forming agent 30 to the template 50 increases. For a pattern size of the concavo-convex pattern, a combined area of side surfaces and a bottom surface of inner walls of each concave portion of the concavo-convex pattern of the template to be filled with the resist is used. Use of such an area enables us to specify the size of the surface area of the pattern size. Thus, the pattern size of the concave portions is smaller, adhesion is higher. This makes it hard to detach the pattern forming agent 30 from the template 30, and increases detachment force to act on the pattern forming agent 30. In addition the smaller the pattern size is, the lower the mechanical strength is, and thus the resist pattern is more likely to be torn. For this reason, when the pattern size is smaller, the number of defects needs to be more reduced to be below an allowable level shown in FIG. 2.

When the pattern size is smaller as shown in P1 of FIG. 2, adhesion of the pattern forming agent 30 to the template 50 is increased. Thus, the pattern forming agent needs to contain demolding agent 31 more, so that detachment of the template 50 from the pattern forming agent 30 can be facilitated. In this case, the condition Cis only below the allowable level.

When the pattern size is larger as shown in P2 of FIG. 2, adhesion of the pattern forming agent 30 to the template 50 is decreased. Thus, as the content of the demolding agent 31 needs to be lower than in the case of P1, it is not preferable to use the content of the demolding agent 31 in the case of the condition C. In this case, the pattern forming agent 30, which is filled in the concave portions of the template 50, is less likely to be torn at the time of demolding. However, the line edge roughness of a pattern formed on the pattern forming agent 30 deteriorates. The line edge roughness deteriorates because a high content of the demolding agent 31 results in an insufficient curing reaction of the resist 32. This makes it difficult to manufacture the line edge with good accuracy.

In order to improve adhesion degree distribution, it is preferable to control the amount of demolding agent so that the amount of the demolding agent covering a surface of a pattern can be almost uniform per unit area of the pattern.

It is generally known that the content of the demolding agent 31 and the number of pattern defects caused by demolding the template have a relation of almost quadratic curve as shown in FIG. 3. Accordingly, in the case of P2 in which the pattern size is larger, it is appropriate to use the content of the demolding agent 31 of the condition B which is close to the allowable level.

It is preferable to use the condition of the demolding agent 31 under which the number of pattern defects has a smaller difference from the allowable level.

Specifically, the demolding agent 31 and the resist 32 are used as described below, for example. FIG. 1 shows a region (first region, reference numeral 71 in FIG. 1) in the central portion of the template 50 where the concavo-convex pattern has high density, and a region (second region, reference numeral 72 in FIG. 1) of the outer side of the template 50 where the concavo-convex pattern has low density. The amount of the demolding agent 31 and the resist 32 to be mixed is adjusted according to the density of the concavo-convex pattern.

Here, the size of a surface of the template 50 is assumed to be 100 um². On the template 50, two regions are formed. One is a region where the concavo-convex pattern has high density. Another is a region where the concavo-convex pattern has low density. In the region of the template 50 where the concavo-convex pattern has high density, a line and space of 1:1 where each concave portion of the concavo-convex pattern has a width of 20 nm and has a depth of 50 nm are formed. The occupancy of the line in the line and space is 50%.

On the other hand, in the region of the template 50 where the concavo-convex pattern has low density, a line pattern where each concave portion of the concavo-convex pattern has a width of 20 nm and has a depth of 50 nm are formed at intervals of 5 μm. The occupancy of a line in a line pattern is 5%.

Here, no pattern is formed in any other region of the template 50.

In the region where the concavo-convex pattern has high density, silicone acrylic resin of about 10 pl (picoliter) is used for the demolding agent 31, and acrylic ultraviolet curable resin of about 250 pl is used for the resist 32. The pattern forming agent 30 is prepared by mixing the demolding agent 31 with the resist 32.

On the other hand, in the region where the concavo-convex pattern has low density, silicone acrylic resin of about 2 pl is used for the demolding agent 31, and acrylic ultraviolet curable resin of about 25 pl is used for the resist 32. Then, the pattern forming agent 30 is prepared by mixing the demolding agent 31 with the resist 32.

The pattern forming agent 30 thus prepared to correspond to the region, where the concavo-convex patter has high density or low density, is dropped onto the substrate 10 on which high density pattern and low density pattern regions can be formed.

Next, the pattern forming agent 30 which is dropped on the substrate 10 is pressed by the template 50 with pressure of about 20 nN. In this case, the pressing operation is performed while a position in the z direction is controlled, so that a distance between the template 50 and the substrate 10 can be 20 nm. Next, ultraviolet light of 257 nm is irradiated with the pattern forming agent 30 for curing the pattern forming agent 30. Next, the template 50 pressed onto the pattern forming agent 30 is detached from the pattern forming agent 30 to form a pattern on the pattern forming agent 30.

In such a manner, an imprint with a fewer pattern defects can be achieved by adjusting a mixture-amount of the demolding agent 31 and the resist 32. The mixture-amount is based on the density of the concavo-convex pattern of the template 50. In other words, an imprint with a fewer pattern defects can be achieved by adjusting the mixture-amount of the demolding agent 31 and the resist 32 according to the concavo-convex pattern formed on the template 50. Note that, the size of the surface of the template 50 mentioned above is shown for simplicity of description. Thus, this is one example. A template which is larger in size than the example is used in reality. It has size of 32 mm×26 mm, for example.

In addition, in the embodiment, the pattern forming agent is dropped by an ink-jet method. Such a method can control the amount of the pattern forming agent 30 to be dropped with accuracy of 0.1 fl (femtoliter) at a maximum.

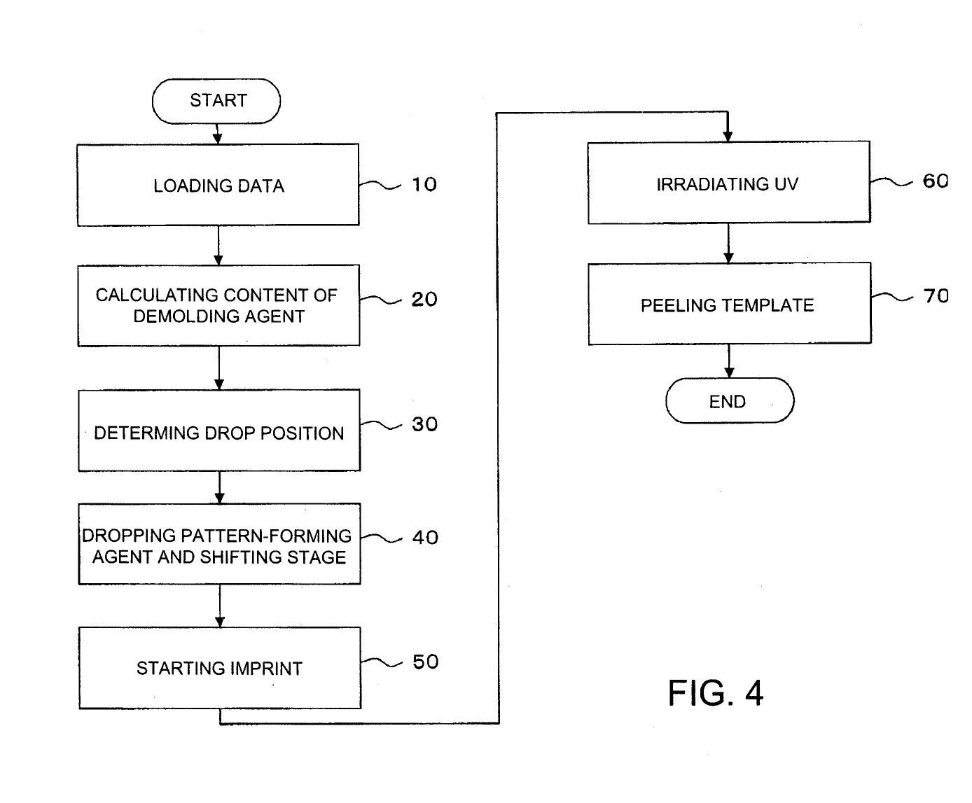

FIG. 4 is a flowchart showing an operation of the imprint lithography apparatus 1.

In block 10, the arithmetic unit 61 retrieves data on the demolding agent 31 and the resist 32 which correspond to the concavo-convex pattern of the template 50 from the database 70.

In block 20, the arithmetic unit 61 calculates a mixing ratio of the demolding agent 31 and the resist 32 (or a content of the demolding agent relative to the resist) on the basis of the data.

In block 30, the determine section 62 determines a position to drop the pattern forming agent 30, which is adjusted on the basis of the mixing ratio of the demolding resist 31 and the resist 32 (or the content of the demolding agent relative to the resist) determined in block 20. The determine unit 62 determines to apply the pattern forming agent 30 having a larger content of the demolding agent 31 to a portion of the pattern forming agent 30 where a small pattern size is formed. On the other hand, the determine unit 62 determines to apply the pattern forming agent 30 having a smaller content of the demolding agent 31 to a portion of the pattern forming agent 30 where a large pattern size is formed. For the pattern size, concavo-convex pattern template data pre-stored in the database 70 is used.

In addition, in block 30, the instruction unit 63 instructs the control units 26, 48, 56, so that the pattern forming agent 30 with the content of the demolding agent 31 calculated by the arithmetic unit 61 can be dropped at the drop positions of the pattern forming agent 30 determined by the determine portion 62.

In block 40, the mixer 41 drops the pattern forming agent 30 through the nozzle 40 with the content of the demolding agent 31 adjusted on the basis of the instruction from the instruction unit 63 through the control section 48. Then, the control units 26, 56 perform control to move the drive units 25, 55, so that the pattern forming agent 30 can be dropped at appropriate positions. Specifically, the movement of the drive portion 55 retreats the template 50 to a position away from the substrate 10, and thus enables the dropping operation. The movement of the drive unit 26 is controlled to be synchronous with the dropping operation.

In block 50, an imprint operation starts in such a manner that the control unit 56 controls the drive unit 55, so that the template 50 can be pressed against the pattern forming agent 30 applied to the substrate 10.

In block 60, with the template 50 pressed on to the pattern forming agent 30 applied to the substrate 10, the irradiation apparatus 51 irradiates the pattern forming agent 30 with ultraviolet light, which penetrates into the template 50, to cure the pattern forming agent 30. Irradiation time is controlled so that the amount of irradiation is equivalent to irradiation energy necessary for photopolymerization reaction of the pattern forming agent 30.

In block 70, in response to an instruction given by the instruction unit 63, the control unit 56 controls the drive unit 55, so that the template 50 can be peeled from the pattern forming agent 30.

Note that the flowchart described above is one example. Thus, there can be other process in the middle of the processes in the flowchart.

Since the use of the imprint lithography apparatus 1 allows the demolding agent to be allocated to a portion with a small concavo-convex pattern and a portion with a large concavo-convex pattern separately, a pattern with a fewer pattern defects can be formed. In addition, distribution within a shot (chip) of force necessary for detachment when a template is peeled can be reduced. Thus, a detachment operation can be performed at a high speed.

Note that, when a resist, which originally has a demolding group in a resin structure, is used as the resist 32, the number of pattern defects in the demolding of the template 50 can be reduced.

In addition, when a template on which a demolding film has been formed in advance is used as the template 50, the number of pattern defects in the demolding of the template 50 can be reduced.

### (Modification 1)

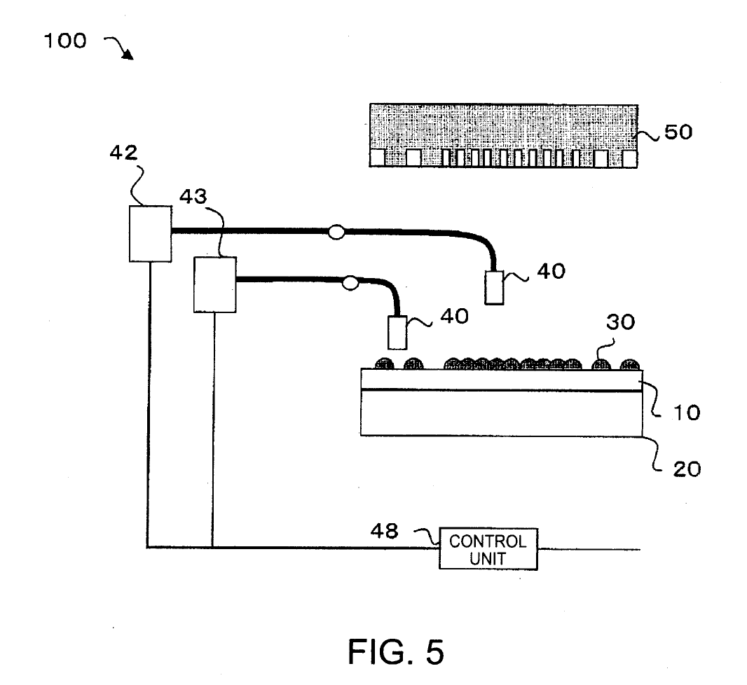

FIG. 5 is a schematic view showing an imprint lithography apparatus 100, which is a modification of the imprint lithography apparatus 1. A description on a configuration similar to that described in the first embodiment will be omitted.

The imprint lithography apparatus 100 is different from the imprint lithography apparatus 1 in that the mixer 41 is not provided. In other words, the tank 42 and the tank 43 are provided separately.

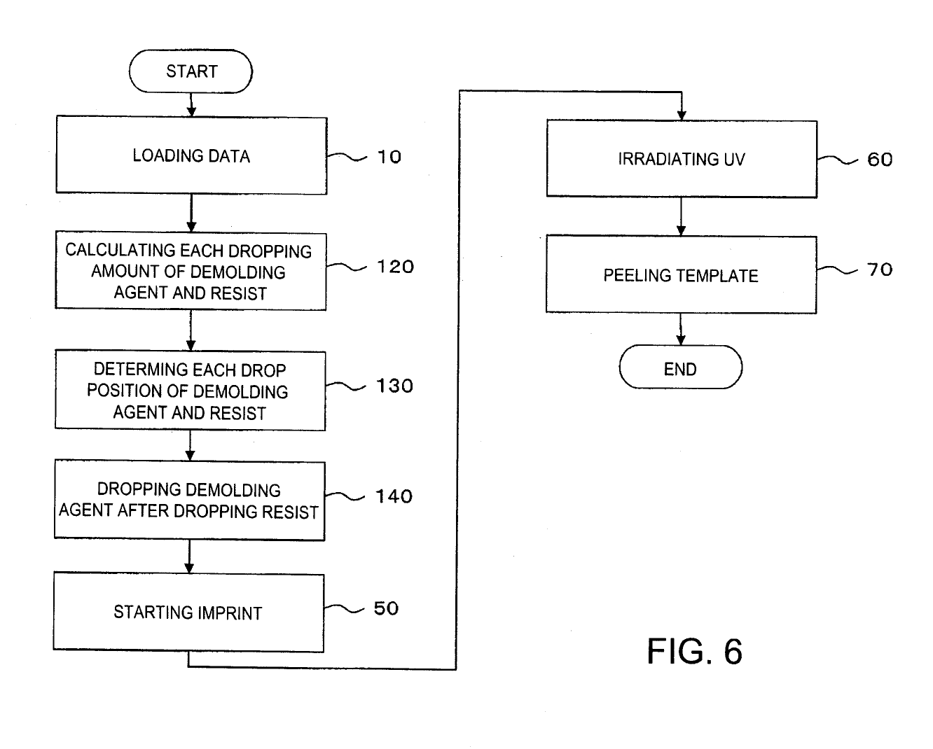

FIG. 6 is a flowchart showing an operation of the imprint lithography apparatus 100. In the operation of the imprint lithography apparatus 100, as operations in block 10 and block 50 to block 70 are similar to those of the imprint lithography apparatus 1, a description of these blocks will be omitted.

In block 120, an arithmetic unit 61 calculates the amount of each of a demolding agent 31 and a resist 32 to be dropped.

In block 130, the determine unit 62 determines positions to drop the demolding agent 31 and the resist 32 adjusted on the basis of the amount of each of the demolding agent 31 and the resist 32 to be dropped which has been calculated in block 120. The determine unit 62 determines the positions to drop the demolding agent 31 and the resist 32 so that they are dropped at the almost same position. In addition, the determine unit 62 determines to apply a larger amount of the demolding agent 31 to be dropped in an area in the shot where a small pattern size is formed. On the one hand, it determines to apply a smaller amount of the demolding agent 31 to be dropped in an area in the shot where a large pattern size is formed. For the pattern size, concavo-convex pattern template data pre-stored in a database 70 is used. The pattern forming agent 30 is formed by being mixed the resist 32 with the demolding agent 31.

In addition, in block 130, an instruction unit 63 instructs control units 26, 48, 56, so that the demolding agent 31 by the amount to be dropped calculated by the calculation unit 61 can be dropped at the drop positions of the demolding agent 31 determined by the determine unit 62 after the resist 32 by the amount to be dropped calculated by the arithmetic unit 61 is dropped at the drop positions of the resist 32 determined by the determine unit 62.

In block 140, the tanks 42, 43 adjust the amounts of the demolding agent 31 and the resist 32, respectively, on the basis of instructions given by the instruction unit 63 through the control unit 48. Then, the demolding agent and the resist are dropped from nozzles 40 connected to the tanks 42, 43, respectively. In this case, the control sections 26, 56 perform control movement of the drive units 25, 55, so that the demolding agent 31 and the resist 32 can be dropped at appropriate positions. The drive unit 55 retreats the template 50 to a position away from the substrate 10. The dropping operation of the demolding agent 31 and the resist 32 from the nozzles 40 is controlled in synchronization with the drive unit 25. After the resist 32 is dropped, the demolding agent 31 is dropped on the resist. An imprint pattern is transferred on a whole surface of the substrate 10, by performing the processes in blocks 50, 60, 70 after dropping the resist agent on a whole surface in the shot and then dropping the demolding agent, and repeating the processes after block 140 for a next shot.

In addition, the flowchart described above is one example. Thus, there can be other process in the middle of the processes in the flowchart.

In addition, the resist agent and demolding agent can be applied to a whole surface within a shot by sequentially repeating the dropping of the demolding agent in a portion in the shot immediately after the dropping of the resist in the portion, and then the dropping of the demolding agent in a next position in the shot after the dropping of the resist in the next position.

In such a manner, with an application method of dropping demolding agent on the dropped resist, a small amount of the demolding agent can exist in an interface between the concavo-convex pattern of the template and the resist, thus enabling adhesion at the time of peeling the template to be reduced efficiently.

In addition, even when inner wall surfaces of the template concavo-convex pattern are rough and a friction force at the time of demolding considerably acts due to the surface roughness, the surface roughness of the template can be covered with a small amount of the demolding agent by placing the demolding agent in the interface between the template concavo-convex pattern and the resist with the application method described above, thus enabling reduction of the friction force.

In the embodiment, as the tanks 42 and 43 are separately provided, the demolding agent and the resist will not mix in the piping. Thus, it is not necessary to clean the piping every time imprint lithography is performed.

Note that, the control units 26, 48, 56 may be controlled as one control unit.

In Modification 1, form of the pattern forming agent varies depending on a difference in solubility of the demolding agent and the resist to be used. When the demolding agent and the resist are incompatible, a demolding film composed of the demolding agent is formed on a surface of the resist by dropping the demolding agent after dropping the resist, thus resulting in a form in which the demolding agent covers the resist. On the other hand, when the demolding agent and the resist are compatible, mixing occurs in an interface between the resist and the demolding agent, resulting in a form in which the demolding agent is impregnated in the resist.

In addition, in Modification 1, the drop positions of the demolding agent and the resist are determined so that they can drop at the almost same position. However, the drop positions of them do not necessarily have to be located at the same position (same coordinate position in the shot) as long as the demolding agent is dropped on the resist.

In Modification 1, when the demolding agent and the resist are dropped separately, it is preferable to control the amount to be dropped, so that the resist can be dropped in the order of pl and the demolding agent can be dropped in the order of fl, by using the ink jet method.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An imprint lithography apparatus comprising:
an arithmetic unit calculating a mixing ratio of a demolding agent and a resist to be contained in a pattern forming agent, wherein the mixing ratio being adjusted on a basis of a pattern size formed on a template;
a mixer mixing the resist and the demolding agent on the basis of a calculation result by the arithmetic unit;
a nozzle dropping the pattern forming agent on a substrate from the mixer; and
an irradiation apparatus irradiating the pattern forming agent dropped on the substrate with light after pressing the template onto the pattern forming agent.

2. The apparatus described in claim 1, wherein
the template comprises at least one of a first region and a second region, wherein each of the regions comprising a different pattern size,
the arithmetic unit calculates a first mixing ratio of the demolding agent and the resist corresponding to the first region, and a second mixing ratio of the demolding agent and the resist corresponding to the second region, and
the mixer mixes the resist and the demolding agent on a basis of the first mixing ratio and the second mixing ratio.

3. The apparatus described in claim 1, wherein
the arithmetic unit preliminarily calculates the mixing ratio from a relation between pattern defects caused in the pattern forming agent after a concavo-convex pattern is formed in the pattern forming agent and the pattern size formed on the template.

4. The apparatus described in claim 3, wherein,
data on the pattern defects and a pattern size of the concavo-convex pattern are stored in a database and the database is connected to the arithmetic unit.

5. The apparatus described in claim 1, wherein,
the resist is at least one of acrylic-based, epoxy-based and vinyl ether-based ultraviolet curable resins, and the demolding agent is at least one of fluorine-based compound, silicone-based compound, and silicone-based acrylic resins.

6. An imprint lithography apparatus comprising:
an arithmetic unit calculating amount of a demolding agent and a resist to be dropped, wherein the demolding agent and the resist being contained in a pattern forming agent, and the amount being adjusted on a basis of a pattern size formed on a template;
a first nozzle dropping the resist on a substrate;
a second nozzle dropping the demolding agent on the resist dropped on the substrate; and
an irradiation apparatus irradiating the pattern forming agent with light after pressing the template onto the resist and the demolding agent dropped on the substrate.

7. The apparatus described in claim 6, wherein
the template comprises at least two regions of a first region and a second region, wherein each of regions comprising a different pattern size, and the arithmetic unit calculates a first amount of the demolding agent and the resist to be dropped corresponding to the first region and a second amount of the demolding agent and the resist to be dropped corresponding to the second region.

8. The apparatus described in claim 6, wherein
the arithmetic unit preliminarily calculates a mixing ratio of the resist and the demolding agent from pattern defects caused in the pattern forming agent after a concavo-convex pattern is formed in the pattern forming agent, and from the pattern size of the template.

9. The apparatus described in claim 8, wherein,
data on the pattern defects and a pattern size of the concavo-convex pattern are stored in a database and the database is connected to the arithmetic unit.

10. The apparatus described in claim 6, wherein,
the resist is at least one of acrylic-based, epoxy-based, and vinyl ether-based ultraviolet curable resins, and the demolding agent is at least one of fluorine-based compound, silicone-based compound, and silicone-based acrylic resins.

11. An imprint lithography method comprising:
calculating a mixing ratio of a demolding agent and a resist to be contained in a pattern forming agent, wherein the mixing ratio being adjusted on a basis of a pattern size formed on a template;
mixing the demolding agent and the resist with a mixer on the basis of the calculation result;
dropping the pattern forming agent on a substrate from the mixer through a nozzle;
irradiating the pattern forming agent dropped on the substrate with light after pressing the template onto the pattern forming agent; and
peeling the template from the pattern forming agent.

12. The method described in claim 11, wherein
in a step of calculating the mixing ratio, the mixing ratio is preliminarily calculated from a relation between pattern defects caused in the pattern forming agent after forming a concavo-convex pattern in the pattern forming agent and a pattern size of the template.

13. An imprint lithography method comprising:
calculating a mixing ratio of a demolding agent and a resist to be contained in a pattern forming agent, wherein the mixing ratio being adjusted on the basis of a pattern size formed on a template;
dropping the resist on a substrate through a first nozzle;
dropping the demolding agent on the resist dropped through a second nozzle;
irradiating the pattern forming agent with light after pressing the template onto the resist and the demolding agent dropped on the substrate; and
peeling the template from the resist and the demolding agent.

14. The method described in claim 13, wherein
in a step of calculating the mixing ratio, the mixing ratio is preliminarily calculated from the pattern defects caused in the pattern forming agent after forming a concavo-convex pattern in the pattern forming agent and, from a pattern size of the template.
